(19) United States
(12) Patent Application Publication
(10) Pub. No.: US 2011/0058615 A1
(43) Pub. Date: Mar. 10, 2011

(54) PREAMBLE GENERATING APPARATUS AND METHOD FOR DIGITAL DIRECT TRANSMISSION SYSTEM

(75) Inventors: Hyung Il PARK, Daejeon (KR); In Gi Lim, Daejeon (KR); Tae Wook Kang, Daejeon (KR); Sung Weon Kang, Daejeon (KR); Chang Hee Hyoung, Daejeon (KR); Jung Hwan Hwang, Daejeon (KR); Kyung Soo Kim, Daejeon (KR); Jung Bum Kim, Daejeon (KR); Sung Eun Kim, Seoul (KR); Seok Bong Hyun, Daejeon (KR); Kyung Hwan Park, Daejeon (KR); Byoung Gun Choi, Daegu (KR); Tae Young Kang, Daejeon (KR); Jin Kyung Kim, Daejeon (KR)

(73) Assignee: Electronics and Telecommunications Research Institute, Daejeon (KR)

(21) Appl. No.: 12/853,517

(22) Filed: Aug. 10, 2010

(30) Foreign Application Priority Data
Sep. 8, 2009 (KR) 10-2009-0084655
Feb. 23, 2010 (KR) 10-2010-0016333

(51) Int. Cl. H04L 27/00

(52) U.S. Cl. 375/259

(57) ABSTRACT

A preamble generating apparatus and method for a digital direct transmission system are disclosed. The preamble generating apparatus for a digital direct transmission system includes: a pseudo-noise (PN) code generation unit generating a PN code; a line coder performing line coding on the PN code received from the PN code generation unit; and a spreading coder performing spread coding on the line-coded PN code received from the line coder.

### CROSS-REFERENCE TO RELATED APPLICATIONS

This application claims the priorities of Korean Patent Application Nos. 10-2009-0084655 filed on Sep. 8, 2009, and 10-2010-0016333 filed on Feb. 23, 2010 in the Korean Intellectual Property Office, the disclosures of which are incorporated herein by reference.

### BACKGROUND OF THE INVENTION

1. Field of the Invention

The present invention relates to a preamble generating apparatus and method for a digital direct transmission system, and more particularly, to a technique of generating a preamble, used for detecting the synchronization of a digital direct transmission system, through a combination of a pseudo-noise code, line coding, and spread coding to thus generate a preamble code having keen autocorrelation characteristics and low cross-correlation characteristics, while overcoming the problem of low frequency noise, thereby improving the performance of synchronization detection.

2. Description of the Related Art

A human body communication system, a technique of transmitting information through a human body unlike the existing wireline or wireless communication system, has a simplified structure by using the characteristics of a human body channel and uses a digital direct transmission scheme to minimize power consumption.

When a digital signal is directly transmitted by a system employing the digital direct transmission scheme, a spreading code is mainly used to overcome the problem of a low signal-to-noise ratio (SNR) and thus secure a desired bit error rate (BER).

FIG. 1 is a schematic block diagram showing the structure of a related art apparatus for generating a preamble for a digital direct transmission system. The related art preamble generating apparatus 100 includes a pseudo-noise (PN) code generation unit 110 and a spreading coder 120.

The PN code used for detecting the synchronization of the digital direct transmission system must have keen autocorrelation characteristics and low cross-correlation characteristics. However, simply spreading the PN code generated by the PN code generation unit 110 of the related art preamble generating apparatus 100 by the spreading coder 120 cannot obtain such keen autocorrelation characteristics and low cross-correlation characteristics, leading to a failure to obtain the desired performance of synchronization detection. The degradation of the performance of synchronization detection makes a gain obtained through spreading useless.

Thus, in order to improve the performance of an overall system, a technique of generating a preamble code having keen autocorrelation characteristics and low cross-correlation characteristics, while overcoming the problem of low frequency noise, is required.

### SUMMARY OF THE INVENTION

An aspect of the present invention provides a preamble generating apparatus and method for a digital direct transmission system capable of generating a preamble, used for detecting the synchronization of a digital direct transmission system, through a combination of a pseudo-noise code, line coding, and spread coding to thus generate a preamble code having keen autocorrelation characteristics and low cross-correlation characteristics, while overcoming the problem of low frequency noise, thereby improving the performance of synchronization detection.

According to an aspect of the present invention, there is provided a preamble generating apparatus for a digital direct transmission system including: a pseudo-noise (PN) code generation unit generating a PN code; a line coder performing line coding on the PN code received from the PN code generation unit; and a spreading coder performing spread coding on the line-coded PN code received from the line coder.

According to another aspect of the present invention, there is provided a preamble generating method for a digital direct transmission system including: generating a pseudo-noise (PN) code; performing line coding on the generated PN code; and performing spread coding on the line-coded PN code.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing the structure of the related art apparatus for generating a preamble for a digital direct transmission system;

FIG. 2 is a schematic block diagram showing the structure of an apparatus for generating a preamble for a digital direct transmission system according to an exemplary embodiment of the present invention;

FIG. 3 illustrates the generation of a preamble by the apparatus for generating a preamble for a digital direct transmission system according to an exemplary embodiment of the present invention; and

FIGS. 4a to 4c are graphs showing the performance of synchronization detection by preambles generated according to an exemplary embodiment of the present invention and the related art.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

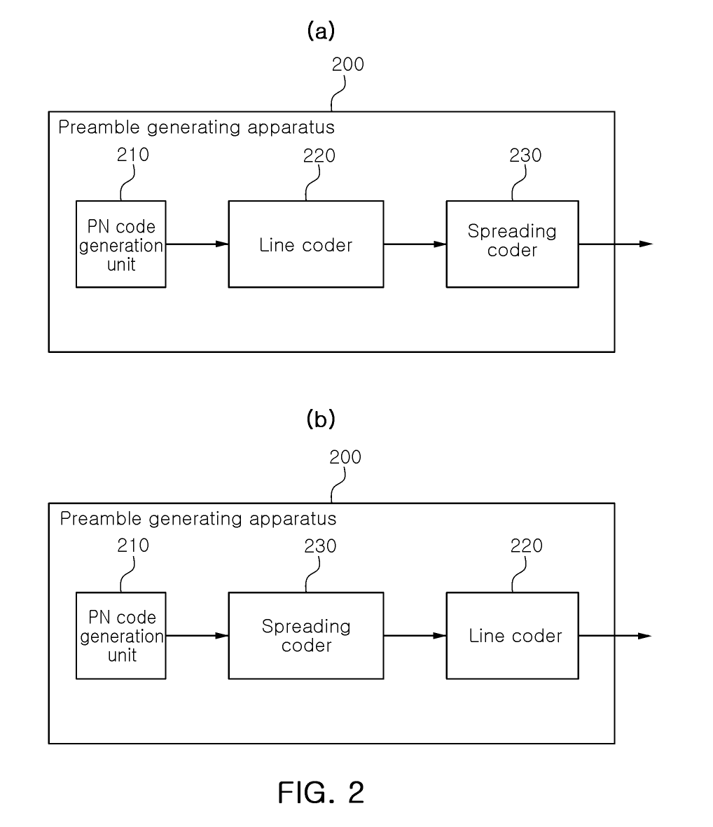

FIG. 2 is a schematic block diagram showing the structure of an apparatus for generating a preamble for a digital direct transmission system according to an exemplary embodiment of the present invention. A preamble generating apparatus 200 according to an exemplary embodiment of the present invention simultaneously uses a spreading code in order to overcome the problem of low frequency noise in a digital direct transmission system and a line coding scheme in order to generate a preamble code having keen autocorrelation characteristics and low cross-correlation characteristics required to perform synchronization detection.

The preamble generating apparatus 200 according to an exemplary embodiment of the present invention may include a pseudo-noise (PN) code generation unit 210, a line coder 220, and a spreading coder 230. According to combinations of the elements, the PN code generation unit 210, the line coder 220, and the spreading coder 230 may be sequentially connected as shown in FIG. 2(a) or the PN code generation unit 210, the spreading coder 230 and the line coder 220 may be sequentially connected as shown in FIG. 2(b).

The PN code generation unit 210, which generates a PN code, may be implemented as one of the existing maximal code generator, nonmaximal code generator, gold code generator and Kasami code generator. The generation of the maximal code, nonmaximal code, gold code, and Kasami code is known to a person having skill in the art, so a detailed description thereof will be omitted.

The line coder 220 receives the PN code from the PN code generation unit 210 and performs line coding thereupon, and in this case, the line coder 220 may perform line coding according to one of the existing NRZ (non-return-to-zero), Unipolar RZ, Bi-Phase-Level, Bi-Phase-Mark, Bi-Phase-Space, and Delay Modulation schemes. The various schemes are known to a person having skill in the art, so a detailed description thereof will be omitted.

The spreading coder 230 receives the PN code which has been line-coded by the line coder 220, and performs spreading coding on the received PN code. For example, the spreading coder 230 may perform spread coding according to a Walsh coding scheme.

Meanwhile, as shown in FIG. 2(b), the line coder 220 and the spreading coder 230 may be interchanged such that the spreading coder 230 receives the PN code generated by the PN code generation unit 210 and performs spread coding thereon and the line coder 220 receives the PM code which has been spread-coded by the spreading coder 230 and performs line coding thereon.

Also, in FIG. 2, it is illustrated that the line coder 220 and the spreading coder 230 are separated. However, because the line coder 220 and the spreading coder 230 perform linear arithmetic operation, respectively, they may be implemented so as to be integrated into a single element to perform both line coding and spread coding together. Also, the results of the PN code generation unit 210 or the results of the line coder 220 may be implemented as a ROM table, whereby a corresponding result may be output according to an input.

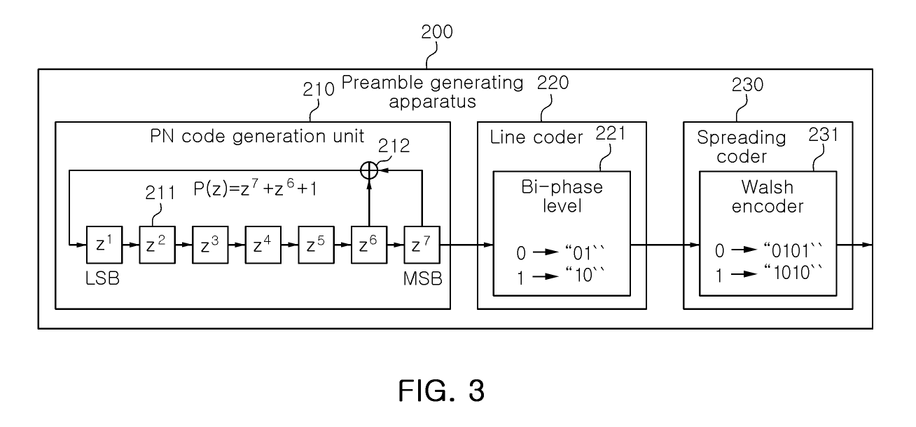

FIG. 3 illustrates the generation of a preamble by the apparatus for generating a preamble for a digital direct transmission system according an exemplary embodiment of the present invention. Specifically, FIG. 3 illustrates a detailed example of generating a preamble by the preamble generating apparatus as shown in FIG. 2(a).

First, the PN code generation unit 210 may generate a PN code by using a generative polynomial expression, for example, ‘P(z)=z⁷+z⁶+1’. In detail, the PN code generation unit 210 may include seven shift registers 211 and a single XOR calculator 212 in order to generate a 128-bit PN code, and the results may be expressed hexidecimally as follows:

P(z)=“8106147916753E87126D6F634BB9957E”

Thereafter, the line coder 220 may perform line coding on the PN code which has been generated by the PN code generation unit 210 according to a bi-phase level scheme 221, among various line coding schemes. In detail, the line coder 220 receives the output of the PN code generation unit 210 and converts 0 into 01 and 1 into 10,thus performing line coding.

Then, the spreading coder 230 performs spread coding on the PN code, which has been line-coded by the line coder 220, according to a Walsh coding scheme. In detail, the spreading coder 230 receives the output of the line coder 220 and converts 0 into 0101 and 1 into 1010,thus performing spread coding.

Meanwhile, when the line coder 200 and the spreading coder 230 are implemented so as to be integrated into a single configuration (i.e., a line and spreading coder), the line and spreading coder receives the output of the PN code generation unit 210 and immediately converts 0 into 01011010 and 1 into 10100101, thus simultaneously performing line coding and spread coding on the PN code.

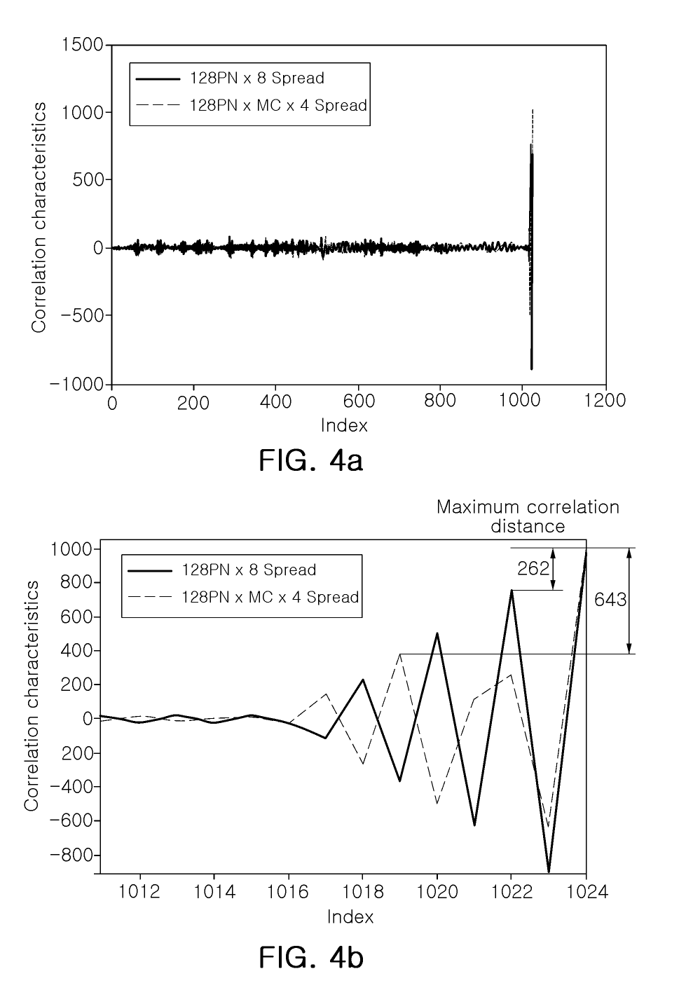

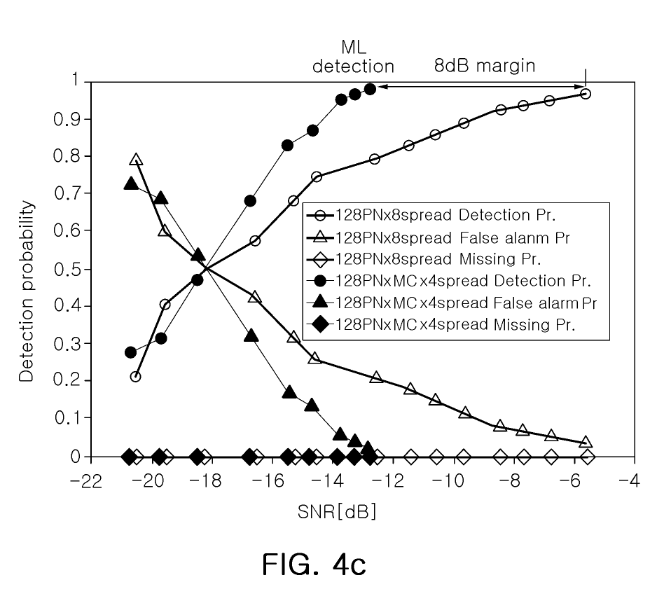

FIGS. 4a to 4c are graphs showing the performance of synchronization detection by preambles generated according to an exemplary embodiment of the present invention and the related art. In FIGS. 4a to 4c, 128PN×8Spread indicates the case of using a preamble generated by the related art preamble generating apparatus, and 128PNxMCx4Spread indicates the case of using a preamble generated by the preamble generating apparatus according to an exemplary embodiment of the present invention.

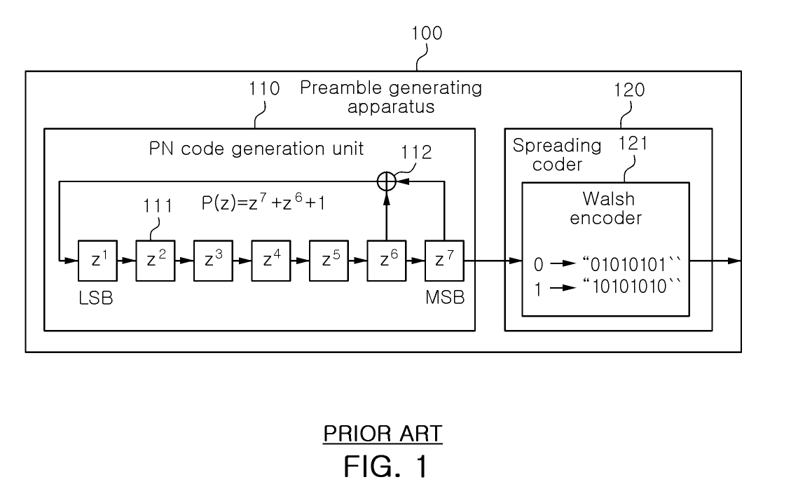

Here, the preamble generating apparatus according to an exemplary embodiment of the present invention generates a preamble according to the embodiment illustrated in FIG. 3. Also, the related art preamble generating apparatus uses the same generative polynomial expression as that of the present invention as shown in FIG. 1 and converts 0 into 01010101 and 1 into 10101010, thus performing spread coding.

FIG. 4a is a graph showing the autocorrelation characteristics of the preamble generated according to an exemplary embodiment of the present invention and the preamble generated according to the related art. FIG. 4b shows an enlargement of only the part of synchronization detection time. It is noted from FIG. 4b that a maximum correlation distance according to the related art is 262, while that according to the present invention is 643. Also, as a result, as shown in FIG. 4c, it is noted that the present invention attains an SNR margin of about 8 dB from a 99% detection probability.

As set forth above, according to exemplary embodiments of the invention, because a preamble is generated through a combination of a pseudo-noise (PN) code, line coding, and spread coding, a preamble code having keen autocorrelation characteristics and low cross-correlation characteristics can be generated, while overcoming the problem of low frequency noise, and thus, the performance of detecting synchronization of the digital direct transmission system can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A preamble generating apparatus for a digital direct transmission system, the apparatus comprising:
a pseudo-noise (PN) code generation unit generating a PN code;
a line coder performing line coding on the PN code received from the PN code generation unit; and
a spreading coder performing spread coding on the line-coded PN code received from the line coder.

2. The apparatus of claim 1, wherein the PN code generation unit generates the PN code according to a pre-set generative polynomial expression.

3. The apparatus of claim 1, wherein the PN code generation unit is implemented as one of a maximal code generator, a nonmaximal code generator, a gold code generator and a Kasami code generator.

4. The apparatus of claim 1, wherein the line coder performs line coding according to one of NRZ (non-return-to-zero), Unipolar RZ, Bi-Phase-Level, Bi-Phase-Mark, Bi-Phase-Space, and Delay Modulation.

5. The apparatus of claim 1, wherein the spreading coder performs spread coding according to a Walsh coding scheme.

6. The apparatus of claim 1, wherein the line coder and the spreading coder are implemented to be integrated to simultaneously perform line coding and spread coding.

7. The apparatus of claim 1, wherein the results of the PN code generation unit or the line coder are implemented as a ROM table to output a result corresponding to an input.

8. A preamble generating apparatus for a digital direct transmission system, the apparatus comprising:
a pseudo-noise (PN) code generation unit generating a PN code;
a spreading coder performing spread coding on the PN code received from the PN code generation unit; and
a line coder performing line coding on the spread-coded PN code received from the spreading coder.

9. A preamble generating method for a digital direct transmission system, the method comprising:
generating a pseudo-noise (PN) code;
performing line coding on the generated PN code; and
performing spread coding on the line-coded PN code.

10. The method of claim 9, wherein, in generating the PN code, the PN code is generated according to a pre-set generative polynomial expression.

11. The method of claim 9, wherein, in generating the PN code, the PN code is generated by one of a maximal code generator, a nonmaximal code generator, a gold code generator and a Kasami code generator.

12. The method of claim 9, wherein, in performing the line coding, the line coding is performed according to one of NRZ (non-return-to-zero), Unipolar RZ, Bi-Phase-Level, Bi-Phase-Mark, Bi-Phase-Space, and Delay Modulation.

13. The method of claim 9, wherein, in performing the spread coding, the spread coding is performed according to a Walsh coding scheme.

14. A preamble generating method for a digital direct transmission system, the method comprising:
generating a pseudo-noise (PN) code;
performing spread coding on the generated PN code; and
performing line coding on the spread-coded PN code.
